(19) United States
(12) Patent Application Publication
(10) Pub. No.: US 2025/0254223 A1
(43) Pub. Date: Aug. 7, 2025

(54) SYSTEM FOR COMMUNICATION USING TERMINAL DEVICE

(71) Applicant: toraru Co., Ltd., Kobe-shi, Hyogo (JP)

(72) Inventor: Jun NISIGUCHI, Kobe (JP)

(21) Appl. No.: 18/724,695

(22) PCT Filed: Jun. 6, 2022
(86) PCT No.: PCT/JP2022/022846

§ 371 Date: Apr. 17, 2025

(30) Foreign Application Priority Data
Dec. 28, 2021 (JP) 2021-215239

(51) Int. Cl. H04L 67/148; G06K 19/06; H04L 67/146; H04W 76/14

(52) U.S. Cl. CPC H04L 67/148; G06K 19/06037; H04L 67/146; H04W 76/14

(57) ABSTRACT

When user X and user Y are communicating using a first terminal device and a second terminal device, respectively, and user Y performs a predetermined operation on the second terminal device, the second terminal device displays a two-dimensional barcode representing terminal identification information of the first terminal device. When user Z captures the two-dimensional barcode using a third terminal device, the third terminal device uses the terminal identification information represented by the captured two-dimensional barcode to obtain the IP address of the first terminal device from a server device and calls the first terminal device. When user X performs an operation to respond to the call, user X and user Z become able to communicate using the first terminal device and the third terminal device, respectively.

### TECHNICAL FIELD

The present invention relates to a system for communication using terminal devices.

### BACKGROUND ART

In communications using terminal devices such as smartphones, there are cases where one of the users changes the terminal device being used while continuing communication with the communication partner.

Mechanisms to meet such needs have been proposed. For example, Patent Document 1 discloses a mechanism in which a server device stores in advance identifiers of two terminal devices (a first terminal device and a second terminal device) used by a first user in association with each other. When the first user is communicating with a second user using the first terminal device, and a switching instruction and the identifier of the communication partner's terminal device are received from the first terminal device, the server device uses the telephone number of the communication partner's terminal device and the stored telephone number of the second terminal device to establish a communication connection between the two terminal devices. This enables communication using the second terminal device and the communication partner's terminal device.

### PRIOR ART DOCUMENT

### Patent Document

Patent Document 1: JP2008-135873A

For example, a user who is communicating with someone while moving with a portable terminal device (e.g., a smartphone) may wish to continue the communication using a terminal device placed at a destination (e.g., a desktop personal computer), even if that terminal device has not had its identifier registered in advance.

Further, a user who is communicating with someone while moving with a portable terminal device may wish to hand over the ongoing communication with the communication partner to another person at the destination.

In view of the above circumstances, the present invention provides a means that enables switching of terminal devices used in communication while continuing the communication.

### SUMMARY

The present invention proposes A system comprising: a first terminal device; a second terminal device; and a third terminal device; wherein each of the first terminal device, the second terminal device, and the third terminal device comprises: an information acquisition module that acquires information issued by a user; a communication interface that transmits own-device acquisition data, which is data representing information acquired by the information acquisition module, to a terminal device of a communication partner of the user, and receives other-device acquisition data, which is data representing information issued by the communication partner and acquired by the terminal device of the communication partner, from the terminal device of the communication partner; and an information output section that outputs, in a form perceivable by the user, information represented by the other-device acquisition data received by the communication interface; wherein, after the first terminal device and the second terminal device have started data communication, the system outputs communication initiation information, which is information for initiating data communication between the first terminal device and the third terminal device, and at least one of the first terminal device and the third terminal device uses the communication initiation information to initiate data communication between the first terminal device and the third terminal device.

### Advantages of the Invention

According to the present invention, it is possible to switch terminal devices used for communication while continuing the communication.

### BRIEF EXPLANATION OF THE DRAWINGS

FIG. 1 shows the overall configuration of a system according to an exemplary embodiment of the present invention.

FIG. 2 schematically shows a terminal identification information display screen displayed by a terminal device according to the exemplary embodiment of the present invention.

FIG. 3 schematically shows a communication initiation screen displayed by a terminal device according to the exemplary embodiment of the present invention.

FIG. 4 schematically shows a communication call screen displayed by a terminal device according to the exemplary embodiment of the present invention.

FIG. 5 schematically shows a communication handover screen displayed by a terminal device according to the exemplary embodiment of the present invention.

FIG. 6 schematically shows a communication takeover screen displayed by a terminal device according to the exemplary embodiment of the present invention.

FIG. 7 schematically shows a communication switching screen displayed by a terminal device according to the exemplary embodiment of the present invention.

FIG. 8A schematically shows the configuration of a system according to a modification example of the present invention.

FIG. 8B schematically shows the configuration of a system according to a modification example of the present invention.

FIG. 9 schematically shows a room entry approval screen displayed by a terminal device according to a modification example of the present invention.

FIG. 10 schematically shows a room entry request screen displayed by a terminal device according to a modification example of the present invention.

FIG. 11 schematically shows a communication handover screen displayed by a terminal device according to a modification example of the present invention.

FIG. 12 schematically shows a communication takeover screen displayed by a terminal device according to a modification example of the present invention.

FIG. 13A illustrates an operation of the system according to a modification example of the present invention.

FIG. 13B illustrates an operation of the system according to a modification example of the present invention.

FIG. 14 schematically shows a communication takeover screen displayed by a terminal device according to a modification example of the present invention.

### DETAILED DESCRIPTION

### Exemplary Embodiment

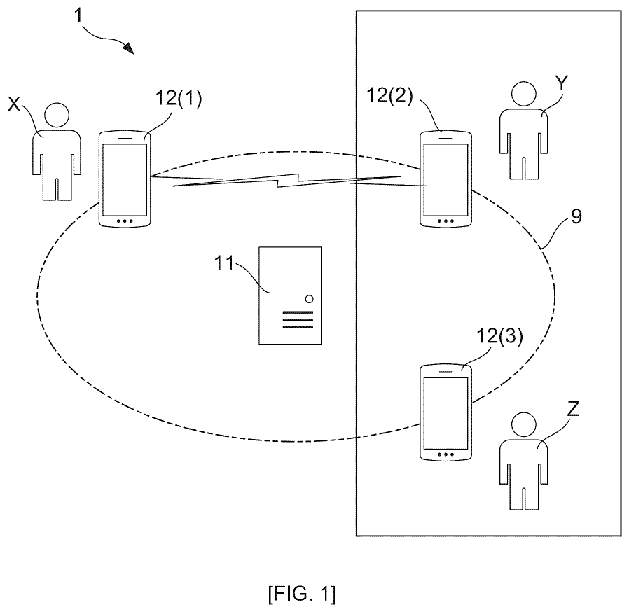

An exemplary embodiment of the present invention will now be described below. FIG. 1 shows the overall configuration of a system 1 according to the exemplary embodiment. System 1 is a system that enables multiple users to communicate using their respective terminal devices. In this embodiment, communication using system 1 is assumed to take place between two users. Note, however, that communications between respective pairs of two users using system 1 may simultaneously be established.

In the present application, the term “user” is not limited to human beings but also includes devices equipped with functions to communicate with humans or other devices (e.g., robots). In addition, the term “communication” in the present application refers to the exchange of information in a form interpretable by a user. The format of information exchanged in communication varies depending on the capabilities of the users engaged in the communication. For example, in communication between humans, or between a human and a device, the terminal device may output information to the user in the form of text display, speech output, or display of gestures such as sign language.

Further, in communication between devices, the terminal device serving as a user may output information in a format not interpretable by humans but interpretable by the device acting as the user. Note that, when the user is a device, the terminal device used by the user may be integrated with the user device itself. For example, in the case where the user is a robot with communication functions, the robot is both the user and the terminal device used by the user.

However, in the following description, it is assumed for convenience that all users are humans.

System 1 comprises a server device 11 and terminal devices 12 used by each user. In the example shown in FIG. 1, three users, namely user X, user Y, and user Z, are illustrated. User X uses terminal device 12(1), user Y uses terminal device 12(2), and user Z uses terminal device 12(3).

Each of the server device 11 and the plurality of terminal devices 12 is capable of performing data communication via the Internet 9.

The hardware of server device 11 is a general-purpose computer for server devices and comprises: a processor for performing various types of data processing; a memory for storing various types of data including programs executed by the processor; and a communication interface for performing data communication with terminal devices 12 via the Internet 9.

The hardware of terminal device 12 is also a general-purpose computer for terminal devices and similarly comprises: a processor for performing various types of data processing; a memory for storing various types of data including programs executed by the processor; and a communication interface for performing data communication with server device 11 via the Internet 9.

Terminal device 12 further comprises a user interface that functions as an information acquisition module for acquiring information issued by the user during communication, and as an information output section for outputting information issued by the communication partner to the user.

Examples of the components of the user interface that function as the information acquisition module include: a microphone (sound pickup unit) that captures voice spoken by the user; a camera (image capturing unit) that captures images of the user's facial expressions or gestures; and input devices such as a keyboard, mouse, or touch panel (information input unit), though not limited thereto. For example, terminal device 12 may also include a haptic sensor that senses pressure, temperature, etc., when touched by the user, as one of the components functioning as the information acquisition module.

Examples of the components of the user interface that function as the information output section include: a speaker (sound emitting unit) that outputs audio to the user; and a display (display unit) that displays images of the communication partner's facial expressions and gestures, or text input by the communication partner, although not limited to these. For example, terminal device 12 may also include a haptic feedback device that conveys pressure, temperature, etc., sensed by the communication partner's haptic sensor, to the user as one of the components functioning as the information output section.

In the following description, it is assumed, as an example, that each terminal device 12 is a tablet PC comprising a microphone, camera, and touch panel as components functioning as the information acquisition module, and a speaker and display as components functioning as the information output section. That is, terminal device 12 includes a touchscreen in which the touch panel and display are integrated. Note that terminal device 12 may be a smartphone that is a tablet PC having the capability to make outgoing and incoming voice calls using telephone numbers via a mobile communication network, but it is not essential that such functionality be provided.

The server device 11 performs data processing according to an application program of the present embodiment (hereinafter referred to as the “server application”) and plays a role in establishing a communication connection between two terminal devices 12 used by two users engaging in communication.

Note that the server device 11 may be composed of a single device or a plurality of devices operating in coordination with each other.

Each terminal device 12 performs data processing according to an application program of the present embodiment (hereinafter referred to as the “terminal application”) and plays a role in enabling communication between users by outputting, to the user, information represented by data received from the terminal device 12 of the user's communication partner, and by acquiring information issued by the user and transmitting data representing the acquired information to the terminal device 12 of the communication partner.

The terminal application may be a program pre-installed on the terminal device 12, or it may be provided to the terminal device 12 in the form of a script included in or referenced from a web page (that is, data describing the display of a web page written in HTML or a similar language) downloaded, for example, from the server device 11, while a web browser program installed on the terminal device 12 is being executed. The terminal application provided in script form is interpreted and executed by the web browser. In the following description, it is assumed, by way of example, that the terminal applications executed on terminal devices 12(1) and 12(2) are programs pre-installed on those terminal devices, whereas the terminal application executed on terminal device 12(3) is a script interpreted by the web browser.

At startup of the terminal application, for example, the terminal device 12 notifies the server device 11 of its own Internet Protocol (IP) address. When the IP address assigned to the communication interface used by the terminal device 12 to connect to the Internet 9 is a local IP address, in order to enable unique identification of the location of terminal device 12 on the Internet 9, the terminal device 12 (or a router performing NAT conversion on the LAN to which terminal device 12 is connected) notifies the server device 11 of a combination of the global IP address assigned to the LAN and a port number used to identify terminal device 12 within the LAN. In the following description, the term “IP address” refers to the global IP address in the case of terminal devices 12 assigned global IP addresses, and to the combination of global IP address and port number in the case of terminal devices 12 assigned local IP addresses.

When the server device 11 receives notification of an IP address from a terminal device 12 as described above, it assigns terminal identification information that is unique within system 1 at that time to the notified IP address and stores the association between the IP address and the terminal identification information in a database. The server device 11 also transmits the assigned terminal identification information to the terminal device 12 that sent the IP address. The terminal identification information may take the form of a numeric string, character string, or the like. Alternatively, the terminal identification information may be a Uniform Resource Locator (URL). A terminal device 12 executing the terminal application may periodically transmit, at fixed intervals, its IP address along with its assigned terminal identification information to the server device 11. The server device 11 deletes from the database any IP address and terminal identification information pair that has not been received from any terminal device 12 for a predetermined period of time.

As an example, the following describes the operation of system 1 in a case where user X and user Y first perform communication, and subsequently, user X and user Z perform communication as a continuation of the same.

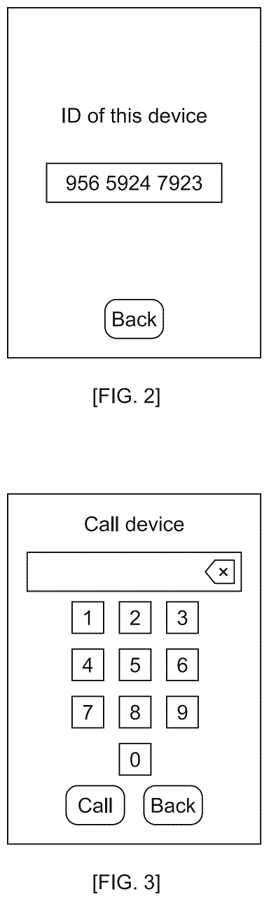

The communication between user X and user Y is initiated, for example, as follows. First, each of user X and user Y performs a predetermined operation on their respective terminal devices 12 running the terminal application, causing the terminal devices 12 to display a terminal identification information display screen (FIG. 2). FIG. 2 schematically shows the terminal identification information display screen. On the terminal identification information display screen (FIG. 2), the terminal identification information currently assigned to the terminal device 12 is displayed.

User X and user Y communicate their respective terminal identification information displayed on the terminal identification information display screen (FIG. 2) to one another. The method by which user X and user Y exchange their terminal identification information may be via telephone, email, chat, or any other suitable method.

For example, user X performs a predetermined operation on terminal device 12(1) running the terminal application to cause the device to display a communication initiation screen (FIG. 3). FIG. 3 schematically shows the communication initiation screen. The communication initiation screen (FIG. 3) displays an input field for terminal identification information. User X inputs the terminal identification information of terminal device 12(2), which was communicated by user Y, into the input field of the communication initiation screen (FIG. 3), and touches the “Call” button.

In response to the touch operation of the “Call” button by user X, terminal device 12(1) transmits an IP address request to server device 11. This IP address request includes the terminal identification information of terminal device 12(2). In response to receiving the IP address request from terminal device 12(1), server device 11 refers to the database to identify the IP address corresponding to the terminal identification information included in the request, and transmits the identified IP address to terminal device 12(1) as the response.

Terminal device 12(1), using the IP address received from server device 11 in response to the IP address request, transmits a connection request to terminal device 12(2). This connection request includes the terminal identification information of terminal device 12(1).

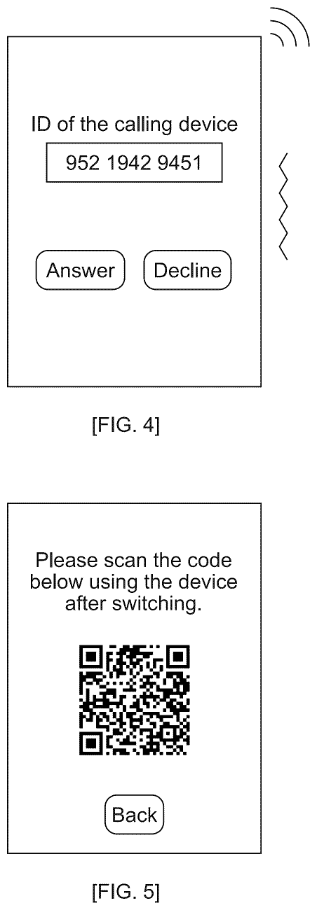

Upon receiving the connection request from terminal device 12(1), terminal device 12(2) displays a communication call screen (FIG. 4) and emits a continuous ringing sound to alert user Y. Additionally or alternatively, terminal device 12(2) may also continuously vibrate. FIG. 4 schematically shows the communication call screen. The communication call screen (FIG. 4) displays the terminal identification information of the calling terminal device 12(1). User Y compares the terminal identification information displayed on the communication call screen (FIG. 4) with the terminal identification information of terminal device 12(1) previously received from user X to confirm that the call is from user X, and then touches the “Answer” button.

When user Y touches the “Answer” button on the communication call screen (FIG. 4), communication between user X and user Y becomes possible using terminal devices 12(1) and 12(2). Specifically, terminal device 12(1) captures audio spoken by user X using a microphone (as an example of an information acquisition module), transmits audio data representing that speech (as an example of own-device acquisition data) to terminal device 12(2), and simultaneously plays back the audio represented by audio data (as an example of other-device acquisition data) received from terminal device 12(2) via a speaker. Likewise, terminal device 12(2) captures audio spoken by user Y using a microphone, transmits audio data representing that speech to terminal device 12(1), and simultaneously plays back the audio received from terminal device 12(1) via a speaker.

In this embodiment, communication between user X and user Y is assumed to be voice-only, but it may be conducted in other forms. For example, the communication may include both voice and video, or consist solely of text display. If user X and user Y are capable of using sign language, the communication may be conducted entirely through video.

The foregoing describes the procedure for initiating communication between user X and user Y. In the above example, user X initiates the call to user Y; however, user Y may alternatively initiate the call to user X. In that case, the roles of terminal devices 12(1) and 12(2) described above are reversed.

After initiating communication with user X as described above, user Y moves close to user Z while maintaining the communication. Then, user Y performs a predetermined operation on terminal device 12(2) to cause the device to display a communication handover screen (FIG. 5). FIG. 5 schematically shows the communication handover screen. The communication handover screen (FIG. 5) displays a two-dimensional barcode that represents communication initiation information, which is information for enabling a terminal device 12 other than terminal device 12(2) to initiate data communication with terminal device 12(1) for the purpose of communication.

In the present embodiment, the communication initiation information is a URL for sending an IP address request regarding terminal device 12(1) to server device 11. This URL includes the terminal identification information of terminal device 12(1).

User Y shows terminal device 12(2), which displays the communication handover screen (FIG. 5), to user Z. User Z operates terminal device 12(3) to launch a program for reading two-dimensional barcodes and captures the two-dimensional barcode within the communication handover screen (FIG. 5) displayed on terminal device 12(2) using the camera of terminal device 12(3). Terminal device 12(3) decodes the two-dimensional barcode captured by the camera and uses the resulting URL to issue a transmission request for a web page to server device 11.

In response to the transmission request from terminal device 12(3), server device 11 first assigns new terminal identification information to terminal device 12(3), and registers the assigned terminal identification information in association with the IP address of terminal device 12(3) in a database. Then, server device 11 refers to the database to identify the IP address corresponding to the terminal identification information of terminal device 12(1), which is included in the transmission request from terminal device 12(3), and transmits to terminal device 12(3) a web page for initiating data communication with terminal device 12(1) using the identified IP address.

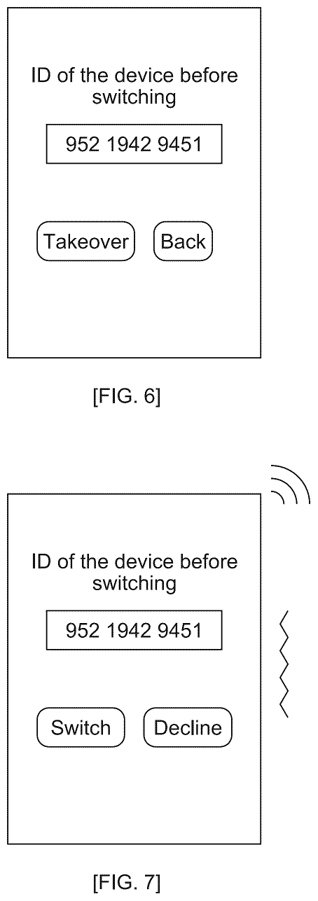

Terminal device 12(3), in response to the transmission from server device 11, displays a communication takeover screen (FIG. 6) based on the received web page. FIG. 6 schematically shows the communication takeover screen. The communication takeover screen (FIG. 6), although not visibly displayed, includes the terminal identification information of terminal device 12(2), which is the communication source device, and the IP address of terminal device 12(1), which is the intended communication partner.

The communication takeover screen (FIG. 6) displays a “Takeover” button. When user Z touches the “Takeover” button displayed on the communication takeover screen (FIG. 6), terminal device 12(3) uses the IP address of terminal device 12(1) to transmit a connection request to terminal device 12(1). This connection request includes the terminal identification information of terminal device 12(2).

Upon receiving the connection request from terminal device 12(3), terminal device 12(1) displays a communication switching screen (FIG. 7). FIG. 7 schematically shows the communication switching screen. The communication switching screen (FIG. 7) displays the terminal identification information of terminal device 12(2) and a “Switch” button. User X verifies that the displayed terminal identification information matches the terminal identification information previously received from user Y and then touches the “Switch” button.

When the “Switch” button on the communication switching screen (FIG. 7) is touched, terminal device 12(1) terminates the data communication for the ongoing communication with terminal device 12(2) and initiates data communication for communication with terminal device 12(3). Thereafter, communication between user X and user Z is conducted via terminal devices 12(1) and 12(3).

According to system 1 as described above, communication that was previously conducted via terminal devices 12(1) and 12(2) can be switched to communication conducted via terminal devices 12(1) and 12(3) through simple user operations.

It should be noted that none of user X, user Y, or user Z is required to perform user registration in order to use system 1.

Although the terminal application for using system 1 may be pre-installed on terminal device 12, such pre-installation is not essential. That is, as long as terminal device 12 is capable of executing a general-purpose web browser, the user may access server device 11 by entering a specified URL in the web browser when using system 1. In doing so, the user can display the communication initiation screen (FIG. 3), terminal identification information display screen (FIG. 2), communication call screen (FIG. 4), communication handover screen (FIG. 5), communication takeover screen (FIG. 6), communication switching screen (FIG. 7), and other such interfaces, and perform communication initiation and handover as described above.

### Modifications

The above-described embodiment is merely one example of the present invention, and various modifications may be made within the scope of the technical concept of the present invention. Examples of such modifications are described below. It should be noted that two or more of the following modification examples may be combined as appropriate.

### Modification Example 1

In the above-described embodiment, the data communication for communication between two terminal devices 12 is performed directly in a peer-to-peer manner without relaying through the Internet 9, but the invention is not limited thereto. For example, data communication for communication between terminal device 12(1) and terminal device 12(2), or between terminal device 12(1) and terminal device 12(3), may be performed via server device 11.

### Modification Example 2

In the above-described embodiment, the data communication for communication between two terminal devices 12 is initiated by the first terminal device 12 obtaining the IP address of the second terminal device 12 from the server device 11, and the second terminal device 12 calling the first terminal device 12 directly using the obtained IP address. However, the invention is not limited thereto. For example, when terminal device 12(1) calls terminal device 12(2), terminal device 12(1) first establishes a first communication connection with server device 11, requests server device 11 to initiate communication with terminal device 12(2), and server device 11, in response to the request, calls terminal device 12(2), establishes a second communication connection between terminal device 12(2) and server device 11, and then mutually connects the first and second communication connections. In this way, a communication connection is established between terminal device 12(1) and terminal device 12(2), and data communication for communication between terminal device 12(1) and terminal device 12(2) may be initiated via that communication connection.

### Modification Example 3

In the above-described embodiment, the server device 11 assigns terminal identification information to each terminal device 12 using system 1, associates and stores the IP address and terminal identification information of the terminal device 12, and converts between terminal identification information and IP address as needed. Instead, server device 11 may omit assigning terminal identification information, and the IP address of terminal device 12 may be used directly as the terminal identification information.

### Modification Example 4

In the above-described embodiment, server device 11 may notify terminal device 12 of the IP address of the communication partner's terminal device 12 for communication. However, it is also possible to adopt a configuration in which the IP address of the other terminal device 12 is not notified. In that case, only the terminal identification information of the communication partner's terminal device 12 is notified to terminal device 12, and the IP address is not notified. Terminal device 12 then transmits the terminal identification information of the communication partner for communication to server device 11, and server device 11 converts from terminal identification information to IP address, specifies the location of the communication partner's terminal device 12 on the Internet, and carries out the call or other processing. According to this modification example, the IP addresses of terminal devices 12 can be kept secret between users engaged in communication.

### Modification Example 5

In the above-described embodiment, when communication that was being conducted between terminal device 12(1) and terminal device 12(2) is switched to communication between terminal device 12(1) and terminal device 12(3), the data communication between terminal device 12(1) and terminal device 12(2) is terminated after user X touches the “Switch” button on the communication switching screen (FIG. 7) and approves the switching of communication. However, the timing for terminating the data communication between terminal device 12(1) and terminal device 12(2) is not limited thereto.

For example, data communication between terminal device 12(1) and terminal device 12(2) may be terminated at the timing when terminal device 12(2) displays the communication handover screen (FIG. 5) or when terminal device 12(1) displays the communication switching screen (FIG. 7). In these cases, since data communication for communication between terminal device 12(1) and terminal device 12(2) is terminated before user X approves the switching of communication, if approval for switching communication is not given by user X even after a predetermined period, data communication for communication between terminal device 12(1) and terminal device 12(2) may be automatically resumed. In such cases, for example, a call may be made from terminal device 12(2) to terminal device 12(1), or from terminal device 12(1) to terminal device 12(2), and upon receiving the call, terminal device 12, either with or without user approval, may resume data communication for communication.

### Modification Example 6

In the above-described embodiment, as the method for transmitting communication initiation information from terminal device 12(2) to terminal device 12(3), a method is employed in which terminal device 12(2) displays an image and terminal device 12(3) captures the image. However, the invention is not limited thereto.

For example, as a method for transmitting communication initiation information from terminal device 12(2) to terminal device 12(3), a method may be employed in which terminal device 12(2) emits a sound representing the communication initiation information, and terminal device 12(3) captures the sound. In this case, the sound emitted by terminal device 12(2) may be human-audible speech representing the communication initiation information, or may be a coded sound representing the communication initiation information that can be decoded by terminal device 12(3).

Additionally, as a method for transmitting communication initiation information from terminal device 12(2) to terminal device 12(3), a method may be employed in which terminal device 12(2) transmits a radio wave representing the communication initiation information, and terminal device 12(3) receives the radio wave. In this case, wireless communication between terminal device 12(2) and terminal device 12(3) may be performed using a peer-to-peer communication protocol such as Bluetooth (registered trademark in Japan) or Wi-Fi Direct (registered trademark in Japan).

Additionally, communication initiation information may be transmitted between terminal device 12(2) and terminal device 12(3) in accordance with the Near Field Communication (NFC) standard. NFC is desirable in that it does not require advance operations, such as pairing, that are necessary for establishing a communication connection in wireless communication based on standards like Bluetooth or Wi-Fi Direct. In this case, terminal device 12(2) is equipped with an NFC reader and writer, which transmits a radio signal representing terminal identification information. Terminal device 12(3) is either equipped with its own NFC reader and writer, or is connected to an external reader and writer, and receives the radio signal representing the terminal identification information by being brought close to terminal device 12(2).

Furthermore, communication initiation information may be transmitted between terminal device 12(2) and terminal device 12(3) through physical movement of the terminal devices. For example, when terminal device 12(2) and terminal device 12(3) are in contact with each other, terminal device 12(2) may generate a vibration representing encoded terminal identification information, which is detected by terminal device 12(3) via a motion sensor, decoded, and used to obtain the terminal identification information. In this case, terminal device 12(2) must include a vibration generator (vibrator), and terminal device 12(3) must include a motion sensor.

The above-described methods using sound, radio waves, or motion are merely examples, and other methods may also be employed. For example, a method that transmits and receives electromagnetic waves such as infrared signals representing terminal identification information, or a method that captures light signals such as screen blinking representing terminal identification information (as one type of electromagnetic signal), may be used.

### Modification Example 7

In the above-described embodiment, terminal device 12(2) and terminal device 12(3) were assumed to be used by different users. However, they may also be used by the same user. For example, terminal device 12(2) may be a portable terminal device carried by user Y, and terminal device 12(3) may be a terminal device placed in user Y's home. User Y may wish to use terminal device 12(3) at home instead of terminal device 12(2) due to reasons such as a larger display or faster communication speed. In such a case, user Y, while communicating with user X via terminal device 12(2), may return home and wish to continue communication with user X using terminal device 12(3). According to system 1, user Y can easily switch the terminal device used for communication with user X.

### Modification Example 8

In the above-described embodiment, communication initiation information including the terminal identification information of terminal device 12(1) is passed from terminal device 12(2) to terminal device 12(3), and terminal device 12(3) calls terminal device 12(1) using the communication initiation information.

Alternatively, communication initiation information including the terminal identification information of terminal device 12(3) may be passed from terminal device 12(3) to terminal device 12(2), and terminal device 12(2) may transmit that communication initiation information to terminal device 12(1), such that terminal device 12(1)

calls terminal device 12(3) using the communication initiation information.

In this modification example, various methods may be employed for passing the communication initiation information from terminal device 12(3) to terminal device 12(2), including the display and capture of a two-dimensional barcode or similar graphical code, the use of sound-based transmission and reception as described in Modification Example 6, or transmission and reception of radio waves. Note that the communication initiation information may be transmitted from terminal device 12(2) to terminal device 12(1) using the communication connection currently employed for data communication between user Y and user X, or a different communication connection may be used.

### Modification Example 9

In a further modification of Modification Example 8, instead of terminal device 12(3) outputting communication initiation information including its own terminal identification information and terminal device 12(2) receiving it, terminal device 12(2) may obtain the communication initiation information from a medium that has previously stored or retained the terminal identification information of terminal device 12(3).

For example, user Z may prepare and place nearby a printed sheet bearing a two-dimensional barcode representing the communication initiation information including the terminal identification information of terminal device 12(3), and terminal device 12(2) may capture the barcode to obtain the communication initiation information.

Alternatively, user Z may prepare a recording and playback device that stores and plays back a sound representing the communication initiation information including the terminal identification information of terminal device 12(3), and terminal device 12(2) may capture the playback sound to obtain the communication initiation information.

Alternatively, user Z may prepare and place nearby an NFC tag (a read-only NFC device) storing the communication initiation information including the terminal identification information of terminal device 12(3), and terminal device 12(2) may read the communication initiation information from the NFC tag.

Alternatively, user Z may prepare and place nearby a vibration generator that stores a vibration pattern representing the communication initiation information including the terminal identification information of terminal device 12(3), and user Y may bring terminal device 12(2) into contact with the vibration generator so that terminal device 12(2) detects the vibration using its motion sensor and thereby obtains the communication initiation information.

### Modification Example 10

In the above-described embodiment, communication conducted using system 1 was assumed to be one-on-one. However, communication conducted using system 1 may also be communication among multiple users.

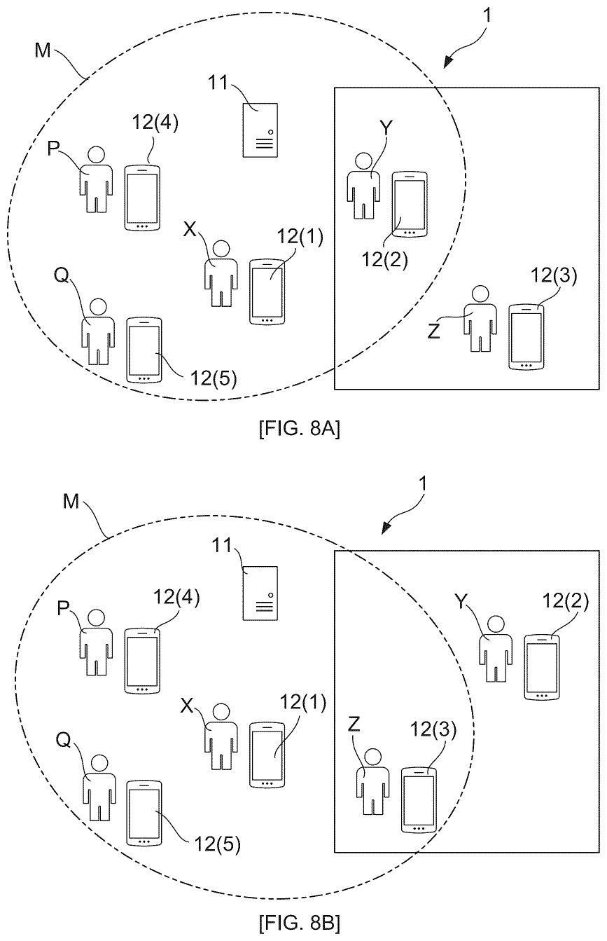

FIGS. 8A and 8B schematically show the configuration of system 1 according to Modification Example 10. FIG. 8A illustrates, as an example, a state of system 1 in which user X and user Y are engaged in multi-party communication within a virtual meeting room M that includes user P and user Q. In this example, user P is using terminal device 12(4), and user Q is using terminal device 12(5). FIG. 8B illustrates a state of system 1 in which user Z, in place of user Y, is participating in multi-party communication with user X and others in meeting room M.

In this modification example, instead of passing the terminal identification information of terminal device 12(1) from terminal device 12(2) to terminal device 12(3), terminal identification information including meeting room identification information for identifying meeting room M is passed.

In this modification example, in addition to the terminal device database, which stores IP addresses and terminal identification information of terminal devices 12 using system 1, server device 11 retains a meeting room database that stores meeting room identification information for identifying meeting rooms opened within system 1, and associates that information with the terminal identification information (or IP addresses) of one or more terminal devices 12 participating in each meeting room. When a user operates terminal device 12 to request the opening of a new meeting room, server device 11 assigns unique meeting room identification information in response to the request, stores the assigned meeting room identification information in the meeting room database, and notifies the terminal device 12 that made the request. The user then communicates the meeting room identification information received from server device 11 to other users who wish to enter the room, via email, chat, or the like. Those users operate their respective terminal devices 12 to display a screen for entering the meeting room, input the meeting room identification information on that screen, and thereby enter the room and communicate with users who have already entered. Server device 11 associates the terminal identification information (or IP address) of the terminal device 12 used by each newly entering user with the corresponding meeting room identification information and stores it in the meeting room database.

A state in which user X, user Y, user P, and user Q have entered meeting room M through the above process is shown in FIG. 8A. In this state, when user Y wishes to have user Z enter meeting room M in their place, user Y displays a communication handover screen (FIG. 5) on terminal device 12(2). However, in this modification example, the two-dimensional barcode displayed on the communication handover screen (FIG. 5) represents communication initiation information including the meeting room identification information for meeting room M.

When user Z uses terminal device 12(3) to capture the two-dimensional barcode displayed on the communication handover screen (FIG. 5), terminal device 12(3) decodes the captured barcode to obtain the meeting room identification information of meeting room M, and uses it to enter meeting room M. As a result, the state shown in FIG. 8B is achieved, and user Z is able to communicate with other users in meeting room M in place of user Y.

In the above-described Modification Example 10, it was assumed that user Y exits meeting room M when user Z enters. However, user Y may remain in meeting room M. In that case, rather than switching room participants, system 1 effectively invites an additional participant to meeting room M.

Furthermore, in the above-described Modification Example 10, it was assumed that terminal device 12(2) and terminal device 12(3) are used by different users, but they may also be used by the same user. In such a case, the user can switch the terminal device 12 used for communication within meeting room M.

In the above-described Modification Example 10, the communication initiation information is passed from terminal device 12(2) to terminal device 12(3) by means of displaying and capturing an image. However, the information may instead be passed via other methods, such as sound transmission and capture, NFC-based transmission and reception, or generation and detection of vibration.

### Modification Example 11

In a further modification of the above-described Modification Example 10, instead of passing communication initiation information including the meeting room identification information of meeting room M from terminal device 12(2) to terminal device 12(3), a configuration may be adopted in which communication initiation information including the terminal identification information of terminal device 12(3) is passed from terminal device 12(3) to terminal device 12(2).

In this modification example, terminal device 12(3) displays the communication handover screen (FIG. 5), and terminal device 12(2) captures the two-dimensional barcode included in the screen. In this case, the two-dimensional barcode displayed on the communication handover screen (FIG. 5) represents communication initiation information including the terminal identification information of terminal device 12(3).

When terminal device 12(2) obtains the communication initiation information, it transmits a call request to server device 11 that includes both the terminal identification information of terminal device 12(3) and the meeting room identification information of meeting room M. Server device 11 retrieves the IP address of terminal device 12(3) corresponding to the terminal identification information included in the call request from the terminal device database and transmits a room entry request, including the meeting room identification information of meeting room M, to the retrieved IP address.

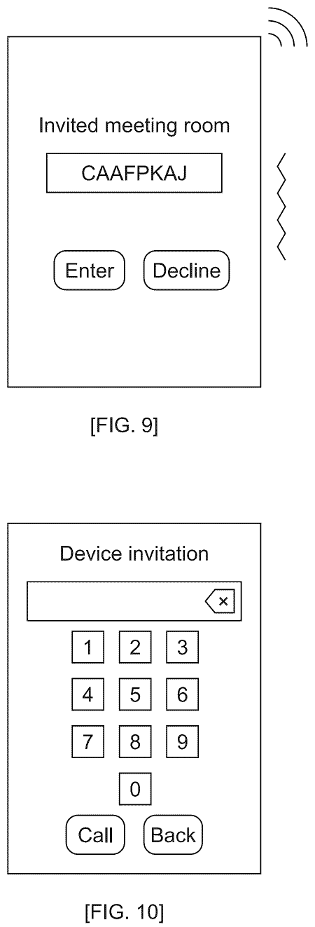

The room entry request transmitted by server device 11 is received by terminal device 12(3). Upon receiving the room entry request, terminal device 12(3) displays a room entry approval screen (FIG. 9). FIG. 9 schematically illustrates the room entry approval screen. The room entry approval screen (FIG. 9) is displayed in place of the communication takeover screen (FIG. 6) described in the embodiment above. Along with displaying the room entry approval screen (FIG. 9), terminal device 12(3) issues a ringing sound, generates vibrations, or the like, to call user Z. When user Z responds to the call and touches the “Enter” button on the room entry approval screen (FIG. 9), terminal device 12(3) enters meeting room M, and user Z is able to communicate with user X and other users in meeting room M.

In this modification example as well, the method for passing communication initiation information is not limited to the method of displaying and capturing an image, but may be performed by other means such as sound transmission and capture, NFC-based transmission and reception, vibration generation and detection, or the like.

Furthermore, in this modification example, the timing at which system 1 transmits the room entry request to terminal device 12(3) is not limited to immediately after terminal device 12(2) receives the communication initiation information from terminal device 12(3). For example, server device 11 may store, in the meeting room database, the terminal identification information (or IP address) of terminal device 12(3) as the destination of the room entry request, in association with the meeting room identification information of meeting room M. Then, in response to a predetermined operation performed by any user in meeting room M (e.g., user X) on a terminal device 12 (e.g., terminal device 12(1)), a transmission request for a room entry request is sent from that terminal device 12 to server device 11. This transmission request includes the meeting room identification information of meeting room M. Upon receiving the transmission request, server device 11 transmits the room entry request to the IP address corresponding to the terminal identification information of terminal device 12(3), as stored in association with the meeting room identification information. According to this configuration, a user who is already in meeting room M can request user Z to enter meeting room M at a desired timing.

According to this modification example, a user who is already in a meeting room can issue a call to a terminal device 12 of a user who has not yet entered the room. The called user can easily enter the meeting room by performing a predetermined operation on their own terminal device 12 in response to the call.

Modification Example 11 may be further modified to provide the above-described convenience even when the user handing over the communication initiation information and the receiving user are located far apart. For example, when user Y and user Z are in different locations, user Z may provide the terminal identification information of terminal device 12(3) to user Y in advance via email, chat, or the like. Then, user Y uses terminal device 12(2) to enter meeting room M and begins a meeting with user X and others (see FIG. 8A).

Subsequently, when user Y wishes to invite user Z into the meeting, user Y displays a room entry request screen (FIG. 10) on terminal device 12(2). FIG. 10 schematically illustrates the room entry request screen. On the room entry request screen (FIG. 10), user Y inputs the terminal identification information of terminal device 12(3) as provided by user Z and touches the “Call” button.

In response to the “Call” button being touched, terminal device 12(2) transmits a call request to server device 11 that includes the terminal identification information entered on the room entry request screen (FIG. 10) and the meeting room identification information of meeting room M. In response to the call request, server device 11 transmits a room entry request including the meeting room identification information of meeting room M to terminal device 12(3). Terminal device 12(3), in response to the room entry request, displays the room entry approval screen (FIG. 9), issues a ringing sound, and so on. User Z can enter meeting room M by touching the “Enter” button on the room entry approval screen (FIG. 9).

### Modification Example 12

In the embodiment described above, communication initiation information is passed from terminal device 12(2) to terminal device 12(3). Alternatively, a configuration may be adopted in which the communication initiation information is passed from server device 11 to terminal device 12(3).

In cases where server device 11 delivers communication initiation information to terminal device 12(3), a configuration may be adopted in which server device 11 identifies the communication initiation information to be delivered based on information received from terminal device 12(2) and terminal device 12(3).

As an example of this modification, the following describes a mode in which server device 11 identifies the communication initiation information to be delivered to terminal device 12(3) based on location information received from terminal devices 12(2) and 12(3).

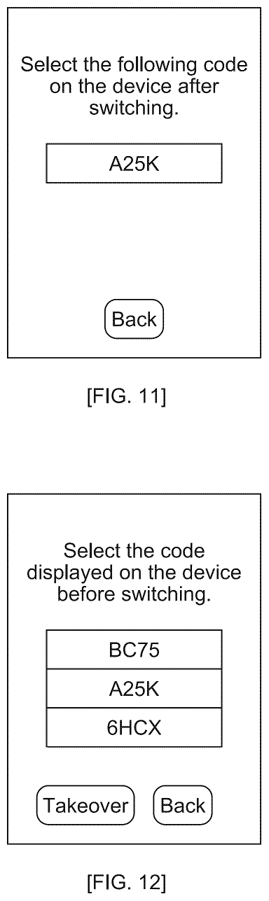

In this mode, when user Y hands over communication with user X to user Z, user Y performs a predetermined operation on terminal device 12(2) to display the communication handover screen shown in FIG. 11. Similarly, user Z performs a predetermined operation on terminal device 12(3) to display the communication takeover screen shown in FIG. 12.

The communication handover screen shown in FIG. 11 is displayed in place of the communication handover screen shown in FIG. 5 in the embodiment described above. Likewise, the communication takeover screen shown in FIG. 12 is displayed in place of the communication takeover screen shown in FIG. 6 in the embodiment described above.

In this mode, terminal devices 12(2) and 12(3) are equipped with functions for determining their own locations. For example, terminal devices 12(2) and 12(3) may include Global Navigation Satellite System (GNSS) units, which determine their own positions based on navigation messages received from satellites, or may include communication units that perform wireless communication according to communication protocols such as Wi-Fi and determine their approximate locations based on information such as the global IP address assigned to the LAN to which the access point belongs.

When terminal device 12(2) displays the communication handover screen (FIG. 11), it generates a code determined according to a predetermined rule based on, for example, the terminal identification information of terminal device 12(2) and time information, and displays the code on the communication handover screen (FIG. 11). Terminal device 12(2) then transmits a communication handover request to server device 11, the request including the IP address of terminal device 12(1) with which terminal device 12(2) is communicating at that time, the location information of terminal device 12(2), and the code displayed on the communication handover screen (FIG. 11).

When terminal device 12(3) displays the communication takeover screen (FIG. 12), it transmits a communication takeover request including its location information to server device 11. At this point, the list displayed on the communication takeover screen (FIG. 12) is empty.

Upon receiving the communication takeover request from terminal device 12(3), server device 11 extracts communication handover requests that include location information indicating a position within a predetermined distance from the position indicated by the location information in the communication takeover request. Server device 11 then generates a list associating the IP addresses and codes contained in the extracted one or more communication handover requests and transmits the list to terminal device 12(3), which is the source of the communication takeover request. The IP address of terminal device 12(1) included in this list is one example of the communication initiation information in this mode.

Upon receiving the list transmitted by server device 11 in response to the communication takeover request, terminal device 12(3) displays the codes included in the list on the communication takeover screen (FIG. 12). User Z selects the code displayed on the communication handover screen (FIG. 11) of terminal device 12(2), as shown by user Y, from the list on the communication takeover screen (FIG. 12), and touches the “Takeover” button. In response to the touch operation, terminal device 12(3) transmits a connection request to terminal device 12(1) using the IP address corresponding to the selected code.

Upon receiving the connection request from terminal device 12(3), terminal device 12(1) displays the communication switching screen (FIG. 7) and calls user X by, for example, emitting a ringing sound or generating vibrations. When user X responds to the call and touches the “Switch” button on the communication switching screen (FIG. 7), the data communication for the communication between terminal devices 12(1) and 12(2) is terminated, and data communication for communication between terminal devices 12(1) and 12(3) is initiated. As a result, user X and user Z are able to communicate.

If only one communication handover request is extracted by server device 11 in response to the communication takeover request, the connection request using the IP address contained in that single communication handover request may be automatically transmitted without waiting for the user to select the code from the list on the communication takeover screen (FIG. 12) and touch the “Takeover” button.

In the mode described above, server device 11 uses the location information of terminal devices 12 to identify the communication initiation information to be transmitted to the terminal device 12 that sent the communication takeover request. However, the method for identifying the communication initiation information to be transmitted is not limited to this approach.

For example, user Z may input into terminal device 12(3) the code (a sequence of at least one of letters, symbols, or numbers) displayed on the communication handover screen (FIG. 11) of terminal device 12(2). Server device 11 may identify the communication initiation information to be transmitted to terminal device 12(3) based on matching the input code. In this mode, terminal device 12(2) transmits a communication handover request to server device 11 that includes the code displayed on the communication handover screen (FIG. 11) and the IP address of terminal device 12(1). Terminal device 12(3) transmits a communication takeover request to server device 11 including the code input by user Z. Upon receiving the communication takeover request, server device 11 searches the currently received communication handover requests for one that contains a code matching the one included in the communication takeover request, and transmits the IP address included in the matched communication handover request to terminal device 12(3). Terminal device 12(3) uses the received IP address to send a connection request to terminal device 12(1).

Additionally, image data representing images (still or video) captured by terminal devices 12(2) and 12(3) may be transmitted to server device 11, and server device 11 may identify the communication initiation information to be transmitted to terminal device 12(3) based on matching the image data. In this mode, when user Y wants to hand over communication with user X to user Z, user Y performs a predetermined operation on terminal device 12(2) to switch from the normal operation mode to a mode for generating a communication handover request, and captures a nearby suitable object using the camera of terminal device 12(2). Terminal device 12(2) then transmits a communication handover request to server device 11, including the image data representing the captured image and the IP address of terminal device 12(1).

Meanwhile, when user Y wants to hand over communication with user X to user Z, user Z performs a predetermined operation on terminal device 12(3) to switch from the normal operation mode to a mode for generating a communication takeover request, and captures the same object as terminal device 12(2) using the camera of terminal device 12(3). Terminal device 12(3) transmits a communication takeover request to server device 11, including the image data representing the captured image.

Upon receiving the communication takeover request, server device 11 searches the currently received communication handover requests for those that include image data representing an image having a similarity above a threshold to the image represented by the image data in the communication takeover request, and transmits the IP address included in the matched communication handover request to terminal device 12(3). Terminal device 12(3) uses the received IP address to send a connection request to terminal device 12(1).

In this mode, the similarity used by server device 11 to match the images in the communication handover request and the communication takeover request may be calculated using any method, such as similarity based on feature values extracted from still images or similarity of motion vectors of feature points in videos.

For example, sound data representing sounds captured by terminal devices 12(2) and 12(3) may be transmitted to server device 11, and the communication initiation information to be transmitted to terminal device 12(3) may be identified through matching based on the sound data. In this mode, when user Y wishes to hand over communication with user X to user Z, user Y performs a predetermined operation on terminal device 12(2) to switch from the normal operation mode to a mode for generating a communication handover request, and captures surrounding sounds using the microphone of terminal device 12(2). Terminal device 12(2) transmits a communication handover request including the captured sound data and the IP address of terminal device 12(1) to server device 11.

Meanwhile, when user Y wishes to hand over communication with user X to user Z, user Z performs a predetermined operation on terminal device 12(3) to switch from the normal operation mode to a mode for generating a communication takeover request, and captures surrounding sounds using the microphone of terminal device 12(3). Terminal device 12(3) transmits a communication takeover request including the captured sound data to server device 11.

At this time, terminal devices 12(2) and 12(3) are located near each other and capture approximately the same sound.

Upon receiving the communication takeover request, server device 11 searches among the communication handover requests received at that time for those that include sound data having a similarity above a threshold to the sound represented by the sound data in the communication takeover request, and transmits the IP address contained in the matched communication handover request to terminal device 12(3). Terminal device 12(3) then transmits a connection request to terminal device 12(1) using the received IP address.

For example, motion data representing physical movements of the terminal devices as detected by motion sensors in terminal devices 12(2) and 12(3) may be transmitted to server device 11, and the communication initiation information to be transmitted to terminal device 12(3) may be identified through matching based on the motion data. In this mode, when user Y wishes to hand over communication with user X to user Z, user Y performs a predetermined operation on terminal device 12(2) to switch from the normal operation mode to a mode for generating a communication handover request. Similarly, user Z performs a predetermined operation on terminal device 12(3) to switch to a mode for generating a communication takeover request.

Next, users Y and Z lightly bump terminal devices 12(2) and 12(3) together. As a result of the impact, both terminal devices receive a shock simultaneously. Terminal device 12(2) transmits a communication handover request to server device 11, including motion data representing the waveform of the shock as detected by the motion sensor, time information indicating when the shock was detected, and the IP address of terminal device 12(1). Terminal device 12(3) transmits a communication takeover request to server device 11, including motion data representing the shock waveform and time information indicating when the shock was detected.

Upon receiving the communication takeover request, server device 11 searches among the currently received communication handover requests for one that includes motion data representing a waveform having a similarity above a threshold to the waveform represented by the motion data in the communication takeover request, and also includes time information indicating a time within a threshold difference from the time indicated by the time information in the communication takeover request. The IP address contained in the matched communication handover request is then transmitted to terminal device 12(3), which sends a connection request to terminal device 12(1) using the received IP address.

The method used by server device 11 to identify the communication initiation information to be transmitted to the terminal device 12 that sent the communication takeover request is not limited to those described above. For example, if terminal devices 12(2) and 12(3) are equipped with odor sensors, odor data sensed by the odor sensors may be used for matching to identify the communication initiation information (such as the IP address of terminal device 12(1)) to be transmitted to terminal device 12(3). Likewise, if terminal devices 12(2) and 12(3) are equipped with haptic sensors (e.g., sensors for measuring temperature, pressure, etc. of contacted objects), haptic data representing temperature, pressure, etc. sensed when terminal devices 12(2) and 12(3) are brought into contact may be used for matching to identify the communication initiation information to be transmitted to terminal device 12(3).

In the above examples, it is assumed that the user of the terminal device communicating with terminal device 12(1) changes before and after switching; that is, user Y is the user of terminal device 12(2), and user Z is the user of terminal device 12(3). However, as described in Modification Example 7, both terminal devices 12 may be used by the same user.

For example, if user Y is communicating with user X (who is using terminal device 12(1)) using their terminal device 12(2) (e.g., a smartphone), and wishes to continue the communication using their terminal device 12(3) (e.g., a desktop PC), the communication with terminal device 12(1) may be switched from terminal device 12(2) to terminal device 12(3) by user Y performing an action such as bumping the two devices together.

In the above example, some of the operations performed by the user on terminal device 12(2) or 12(3) (e.g., switching to the communication handover request mode) or actions performed by the devices (e.g., displaying the switching screen) may be omitted. For example, when the user of the terminal device before switching and the user of the terminal device after switching are the same, it is possible that switching between the same set of terminal devices 12 will occur frequently. Therefore, terminal identification information for multiple terminal devices 12 that may potentially be used for communication handover may be stored in advance in one of the devices (e.g., server device 11 or terminal device 12) in an associated manner. When a communication handover request is made between those associated terminal devices, communication switching may be performed between them without prompting the user for confirmation.

### Modification Example 13

In the embodiment described above, communication is switched from that between terminal devices 12(1) and 12(2) to that between terminal devices 12(1) and 12(3). In this case, terminal device 12(1) participates in the communication both before and after the switching. Alternatively, it may be possible to switch communication such that all participants are replaced before and after the switching.

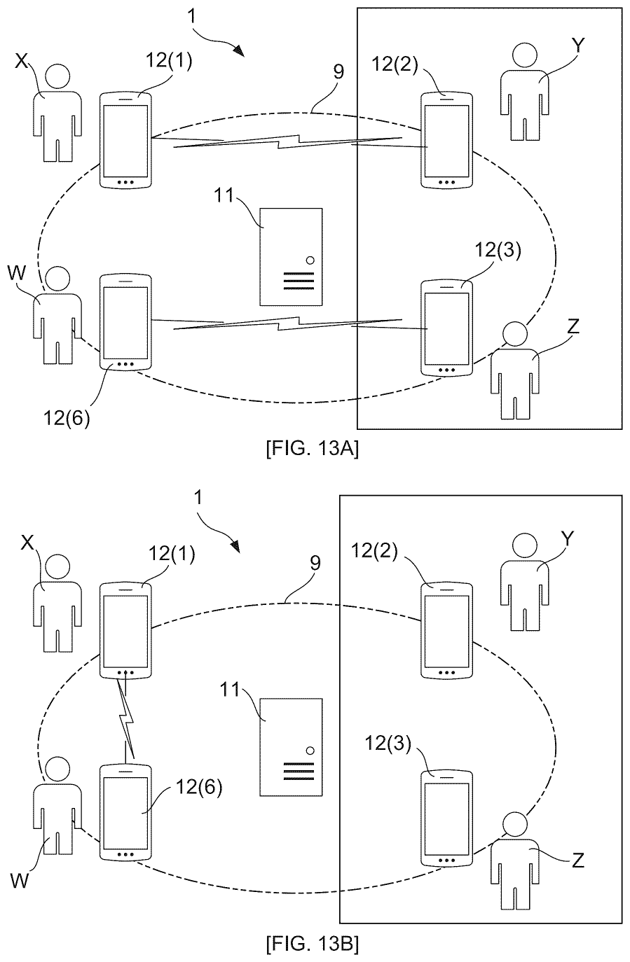

FIGS. 13A and 13B are diagrams for explaining the operation of system 1 in this modification example. Users Y and Z are present at the venue of a product exhibition. User X is an employee of the product manufacturer and has the role of providing explanations about the products to potential customers visiting the product exhibition. However, user X is located remotely from the exhibition venue. User Y is present at the product exhibition venue as a representative of user X and has the role of mediating communication between user X and potential customers.

User W is a potential customer interested in a product on display at the product exhibition. However, user W is also located remotely from the venue. User Z is present at the exhibition venue as a representative of user W and has the role of mediating communication between the product explainer and user W.

Under the circumstances described above, user X, who is using terminal device 12(1), is communicating with user Y, who is using terminal device 12(2), and user Z, who is using terminal device 12(3), is communicating with user W, who is using terminal device 12(6) (FIG. 13A).

In this state, user X and user W exchange information via users Y and Z. For example, user W conveys a question to user Z, who in turn conveys the question to user Y in front of them. User Y then conveys the question to user X. User X responds to the question and sends the answer to user Y, who conveys the answer to user Z, and user Z conveys it to user W.

Such information exchange through relayed communication is inefficient, and as the content of communication becomes more complex, it becomes desirable for user X and user W to communicate directly. In such a case, user Y performs a predetermined operation on terminal device 12(2) to display the communication handover screen (FIG. 5) on terminal device 12(2). Here, the two-dimensional barcode displayed on the communication handover screen (FIG. 5) represents communication initiation information that includes the IP address of terminal device 12(1).

User Z uses the camera of terminal device 12(3) to capture the two-dimensional barcode included in the communication handover screen (FIG. 5) displayed on terminal device 12(2). Terminal device 12(3) decodes the captured two-dimensional barcode and obtains the communication initiation information. Then, terminal device 12(3) transmits the obtained communication initiation information to terminal device 12(6).

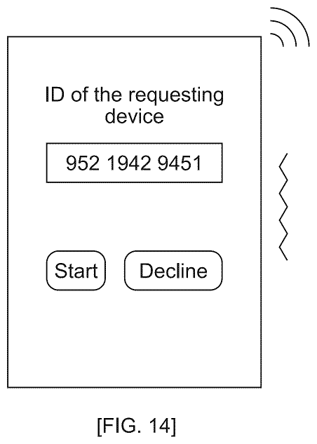

Terminal device 12(6) uses the IP address included in the communication initiation information received from terminal device 12(3) to transmit a connection request to terminal device 12(1). Upon receiving the connection request, terminal device 12(1) displays a communication takeover screen (FIG. 14) and calls user W by, for example, emitting a ringing sound. When user W responds to the call and touches the “Start” button on the communication takeover screen (FIG. 14), the data communication for the communication between terminal devices 12(1) and 12(2), and the data communication between terminal devices 12(3) and 12(6), are both terminated, and a new data communication for communication between terminal devices 12(1) and 12(6) is initiated (FIG. 13B). As a result, user X and user W can communicate directly.

In the above-described mode of this modification example, a configuration is adopted in which the communication initiation information including the IP address of terminal device 12(1) is handed over from terminal device 12(2) to terminal device 12(3), then transmitted from terminal device 12(3) to terminal device 12(6), and terminal device 12(6) uses the IP address included in the communication initiation information to call terminal device 12(1). Alternatively, a configuration may be adopted in which the communication initiation information including the IP address of terminal device 12(6) is handed over from terminal device 12(3) to terminal device 12(2), then transmitted from terminal device 12(2) to terminal device 12(1), and terminal device 12(1) uses the IP address included in the communication initiation information to call terminal device 12(6).

Further, in the above-described mode of this modification example, the method for handing over the communication initiation information from terminal device 12(2) to terminal device 12(3) is based on image display and capture, but the method is not limited to this. For example, the communication initiation information may also be handed over using other methods such as sound transmission and capture, transmission and reception via NFC, or vibration generation and detection.

1. A system comprising:
a first terminal device;
a second terminal device; and
a third terminal device;
wherein each of the first terminal device, the second terminal device, and the third terminal device comprises:
an information acquisition module that acquires information issued by a user;
a communication interface that transmits own-device acquisition data, which is data representing information acquired by the information acquisition module, to a terminal device of a communication partner of the user, and receives other-device acquisition data, which is data representing information issued by the communication partner and acquired by the terminal device of the communication partner, from the terminal device of the communication partner; and
an information output section that outputs, in a form perceivable by the user, information represented by the other-device acquisition data received by the communication interface;
wherein,
after the first terminal device and the second terminal device have started data communication,
the system outputs communication initiation information, which is information for initiating data communication between the first terminal device and the third terminal device, and
at least one of the first terminal device and the third terminal device uses the communication initiation information to initiate data communication between the first terminal device and the third terminal device.

2. The system according to claim 1,
wherein
the second terminal device outputs the communication initiation information including terminal identification information for identifying the first terminal device,
the third terminal device acquires the communication initiation information, and
the third terminal device uses the communication initiation information to initiate data communication with the first terminal device.

3. The system according to claim 1,
wherein
the third terminal device outputs the communication initiation information including terminal identification information for identifying the third terminal device,
the first terminal device acquires the communication initiation information via the second terminal device, and
the first terminal device uses the communication initiation information to initiate data communication with the third terminal device.

4. The system according to claim 1, further comprising:
a medium different from the third terminal device that holds or stores the communication initiation information including terminal identification information for identifying the third terminal device,
wherein
the medium outputs the communication initiation information,
the first terminal device acquires the communication initiation information via the second terminal device, and
the first terminal device uses the communication initiation information to initiate data communication with the third terminal device.

5. The system according to claim 1,
wherein
the second terminal device outputs the communication initiation information including meeting room identification information for identifying a virtual meeting room in which the first terminal device and the second terminal device are engaged in data communication,
the third terminal device acquires the communication initiation information, and
the third terminal device uses the communication initiation information to initiate data communication with the first terminal device.

6. The system according to claim 5,
wherein
the third terminal device outputs the communication initiation information including terminal identification information for identifying the third terminal device, and
the system further comprises:
a server device that receives, from the second terminal device, the communication initiation information including terminal identification information for identifying the third terminal device and the meeting room identification information, and transmits a room entry request for the virtual meeting room to the third terminal device using the communication initiation information.

7. The system according to claim 1, further comprising:
a server device that generates the communication initiation information including terminal identification information for identifying the first terminal device based on information received from the second terminal device and the third terminal device, and transmits the communication initiation information to the third terminal device;
wherein
the third terminal device uses the communication initiation information received from the server device to initiate data communication with the first terminal device.

8. The system according to claim 1, further comprising:
a server device that generates the communication initiation information including terminal identification information for identifying the third terminal device based on information received from the second terminal device and the third terminal device, and transmits the communication initiation information to the first terminal device;
wherein
the first terminal device uses the communication initiation information received from the server device to initiate data communication with the third terminal device.

9. The system according to claim 7,
wherein
the server device generates the communication initiation information based on location information of the second terminal device received from the second terminal device and location information of the third terminal device received from the third terminal device.

10. The system according to claim 7,
wherein
the server device generates the communication initiation information based on a code received from the second terminal device and a code received from the third terminal device.

11. The system according to claim 7,
wherein
the server device generates the communication initiation information based on image data representing an image captured by the second terminal device and image data representing an image captured by the third terminal device.

12. The system according to claim 7,
wherein
the server device generates the communication initiation information based on sound data representing sound captured by the second terminal device and sound data representing sound captured by the third terminal device.

13. The system according to claim 7,
wherein
the server device generates the communication initiation information based on motion data representing physical motion of the second terminal device sensed by the second terminal device and motion data representing physical motion of the third terminal device sensed by the third terminal device.

14. A system comprising:
a first terminal device;
a second terminal device;
a third terminal device; and
a fourth terminal device;
wherein
each of the first terminal device, the second terminal device, the third terminal device, and the fourth terminal device comprises:
an information acquisition module that acquires information issued by a user;
a communication interface that transmits own-device acquisition data, which is data representing information acquired by the information acquisition module, to a terminal device of a communication partner of the user, and receives other-device acquisition data, which is data representing information issued by the communication partner and acquired by the terminal device of the communication partner, from the terminal device of the communication partner; and
an information output section that outputs, in a form perceivable by the user, information represented by the other-device acquisition data received by the communication interface;
wherein
after the first terminal device and the second terminal device have started data communication, and the third terminal device and the fourth terminal device have started data communication,
the second terminal device outputs communication initiation information including terminal identification information for identifying the first terminal device for initiating data communication between the first terminal device and the fourth terminal device,
the third terminal device transmits the communication initiation information acquired from the second terminal device to the fourth terminal device, and
the fourth terminal device uses the communication initiation information to initiate data communication with the first terminal device.

15. The system according to claim 1,
wherein
the system outputs the communication initiation information in a form of an image.

16. The system according to claim 1,
wherein
the system outputs the communication initiation information in a form of sound.

17. The system according to claim 1,
wherein
the system outputs the communication initiation information in a form of electromagnetic waves.

18. The system according to claim 17,
wherein
the system outputs the communication initiation information in a form of radio waves in accordance with a short-range wireless communication standard.

19. The system according to claim 1,
wherein
the system outputs the communication initiation information in a form of physical motion of the terminal device outputting the communication initiation information.

20. The system according to claim 1,
wherein
the system outputs the communication initiation information as encoded communication initiation information that can be decoded by a terminal device that acquires the communication initiation information.
